(19) United States
(12) Patent Application Publication
(10) Pub. No.: US 2022/0020026 A1
(43) Pub. Date: Jan. 20, 2022

(54) ANTI-MONEY LAUNDERING METHODS AND SYSTEMS FOR PREDICTING SUSPICIOUS TRANSACTIONS USING ARTIFICAL INTELLIGENCE

(71) Applicant: MASTERCARD INTERNATIONAL INCORPORATED, Purchase, NY (US)

(72) Inventors: Hardik Wadhwa, Bangalore (IN); Puneet Vashisht, Gurgaon (IN); Gaurav Dhama, Gurgaon (IN); Nitendra Rajput, Gurgaon (IN)

(73) Assignee: MASTERCARD INTERNATIONAL INCORPORATED, Purchase, NY (US)

(21) Appl. No.: 17/376,832

(22) Filed: Jul. 15, 2021

(30) Foreign Application Priority Data
Jul. 17, 2020 (IN) 202041030578

(51) Int. Cl. G06Q 20/40

(52) U.S. Cl. CPC G06Q 20/4016

(57) ABSTRACT

Embodiments provide anti-money laundering methods, and systems for detecting potential money laundering financial transactions using artificial intelligence. The method performed by a server system includes receiving data elements associated with financial activities of users who are associated with at least one issuer. The data elements include transaction data associated with users. The method includes identifying graph features based on data elements, and creating temporal knowledge graph based on the graph features. The temporal knowledge graph represents a computer-based graph representation of the users as nodes and relations among the nodes as edges. The method further includes encoding temporal knowledge graph into graph embedding vector using graph embedding model, predicting occurrence of money laundering financial transaction by applying unsupervised machine learning algorithm over graph embedding vector, and providing alert notification to at least one issuer associated with the money laundering financial transaction based on step of predicting.

### TECHNICAL FIELD

The present disclosure relates to anti-money laundering methods and systems for predicting suspicious transactions and, more particularly, detecting potential money-laundering financial transactions in near real-time by utilizing graph database and adaptive artificial intelligence techniques.

### BACKGROUND

Money laundering (ML) is a process of disguising an illicit origin of “dirty” money and making them appear legitimate. It is a dynamic three-stage process that requires: (a) placement: moving the funds from direct association with the crime; (b) layering: disguising trail to foil pursuit; and (c) integration: making money available to the criminal once again with the occupational and geographic origins hidden from view. For example, when financial transactions occur at an issuer, the issuer determines whether these financial transactions are related to money laundering activities or not. These operations are typically performed by individuals or legal entities that look at a number of related facts and circumstances to make such determinations. Sometimes, it is very difficult for individuals to ascertain full scope of actions and activities related to the financial transactions that may be involved in money laundering activities.

Current strategies of anti-money laundering (AML) system expect laws and regulations to be established to prevent and suppress money laundering activities. For example, possible measures of banks include validating customer identification validation before banking business, checking suspicious foreign exchange cash transactions, tracking large cash flows, and blacklisting accounts of suspected money laundering, etc. In addition, the AML system is composed of some components such as customer identification, transaction monitoring, case management, reporting system, etc. Among them, the customer identification is one of the most important tasks as the customer identification assists AML experts in monitoring customer behaviors, transaction amounts, transaction frequencies, etc. In general, a customer is identified manually by searching customer databases using query tools provided by database management system.

However, existing anti-money laundering (AML) methods rely on human intervention, and applying inefficient data mining techniques. Thus, there is a need for a technical solution to effect anti-money laundering or other crime preventing technologies via electronic means to an unprecedented manner/degree, through use of artificial intelligence and machine learning.

### SUMMARY

Various embodiments of the present disclosure provide systems, methods, electronic devices and computer program products for detecting potential money laundering financial transactions.

In an embodiment, a computer-implemented method for detecting potential money laundering financial transactions is disclosed. The computer-implemented method performed at a server system includes receiving data elements associated with financial activities of a plurality of users. The data elements include transaction data associated with the plurality of users. The plurality of users are associated with at least one issuer. The computer-implemented method includes identifying a plurality of graph features based in part on the data elements and creating a temporal knowledge graph based in part on the plurality of graph features. The temporal knowledge graph represents a computer-based graph representation of the plurality of users as nodes and relations among the nodes as edges. The computer-implemented method includes encoding the temporal knowledge graph into a graph embedding vector using a graph embedding model, predicting an occurrence of a money laundering financial transaction by applying an unsupervised machine learning algorithm over the graph embedding vector, and providing an alert notification to the at least one issuer associated with the money laundering financial transaction based at least on a step of the predicting.

In another embodiment, a server system is disclosed. The server system includes a communication interface, a memory including executable instructions, and a processor communicably coupled to the communication interface. The processor is configured to execute the executable instructions to cause the server system to at least receive data elements associated with financial activities of a plurality of users. The data elements include transaction data associated with the plurality of users. The plurality of users are associated with at least one issuer. The server system is further caused to identify a plurality of graph features based in part on the data elements and create a temporal knowledge graph based in part on the plurality of graph features. The temporal knowledge graph represents a computer-based graph representation of the plurality of users as nodes and relations among the nodes as edges. The server system is further caused to encode the temporal knowledge graph into a graph embedding vector using a graph embedding model, predict an occurrence of a money laundering financial transaction by applying an unsupervised machine learning algorithm over the graph embedding vector, and provide an alert notification to the at least one issuer associated with the money laundering financial transaction based on the prediction.

In yet another embodiment, a yet another computer-implemented method for detecting potential money laundering financial transactions is disclosed. The computer-implemented method performed at a server system includes receiving data elements associated with financial activities of a plurality of users. The data elements include transaction data associated with the plurality of users. The plurality of users are associated with at least one issuer. The computer-implemented method includes identifying a plurality of graph features based in part on the data elements and generating a temporal knowledge graph based in part on the plurality of graph features. The temporal knowledge graph represents a computer-based graph representation of the plurality of users as nodes and relations among the nodes as edges. The computer-implemented method includes encoding the temporal knowledge graph into a graph embedding vector using a graph embedding model. The graph embedding model represents a combination of node embedding, edge embedding and subtree graph embedding algorithms. The computer-implemented method includes predicting an occurrence of a money laundering financial transaction by applying a long short term memory (LSTM) network algorithm over the graph embedding vector, and providing an alert notification to the at least one issuer associated with the money laundering financial transaction based on the predicting step.

### BRIEF DESCRIPTION OF THE FIGS

For a more complete understanding of example embodiments of the present technology, reference is now made to the following descriptions taken in connection with the accompanying drawings in which:

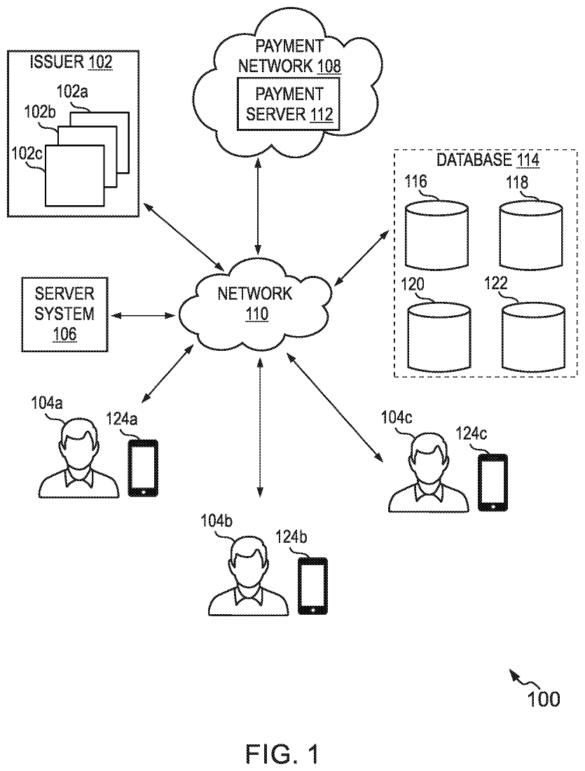

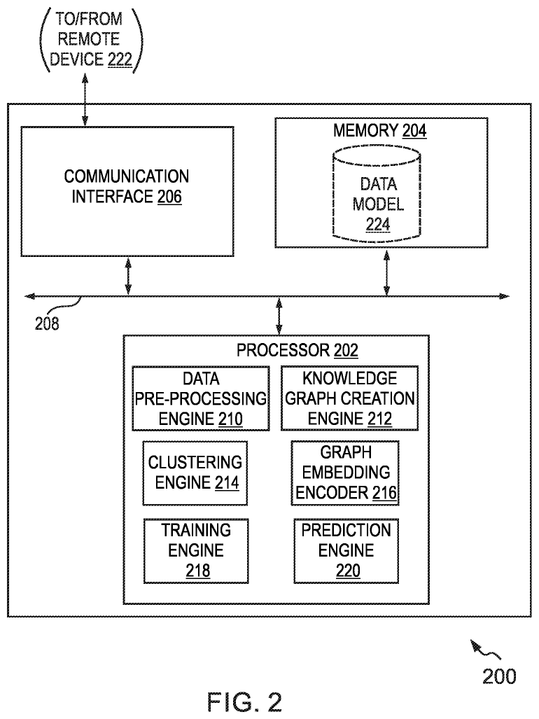

FIG. 1 is an example representation of a system, related to at least some example embodiments of the present disclosure;

FIG. 2 is a simplified block diagram of a server system, in accordance with one embodiment of the present disclosure;

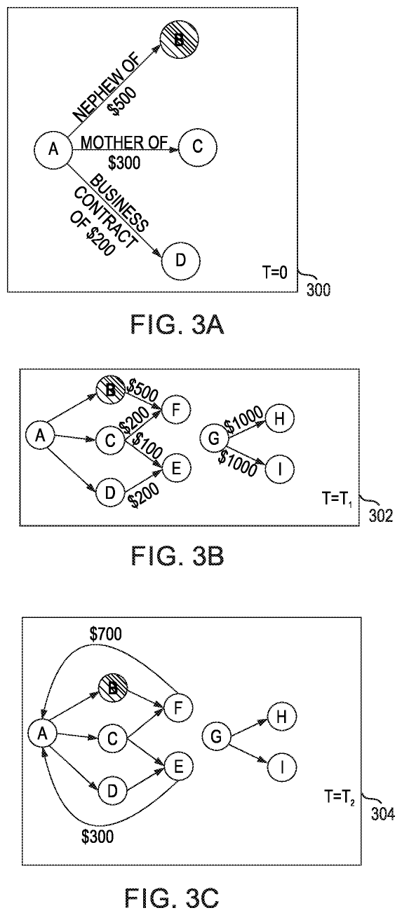

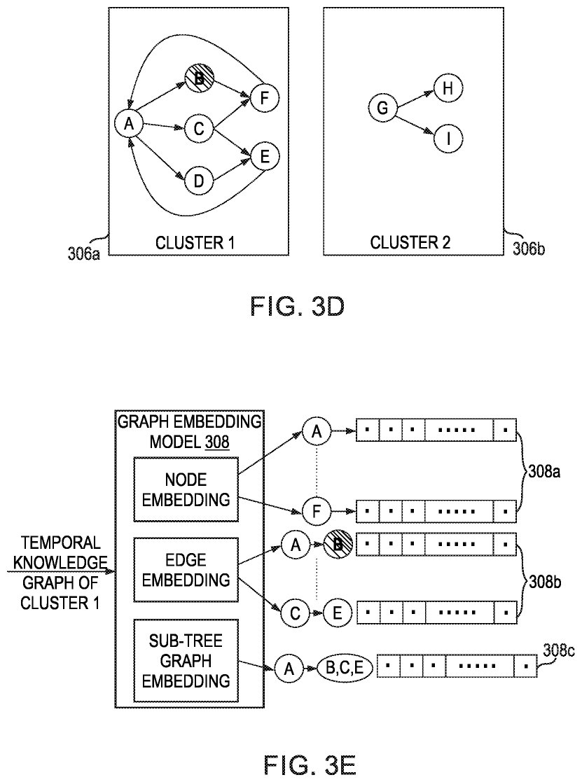

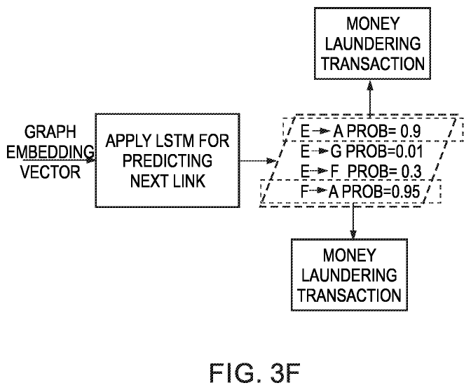

FIGS. 3A-3F, collectively, represent example representations of a process for predicting a probable money laundering financial transaction on a real time basis using the server system, in accordance with an example embodiment;

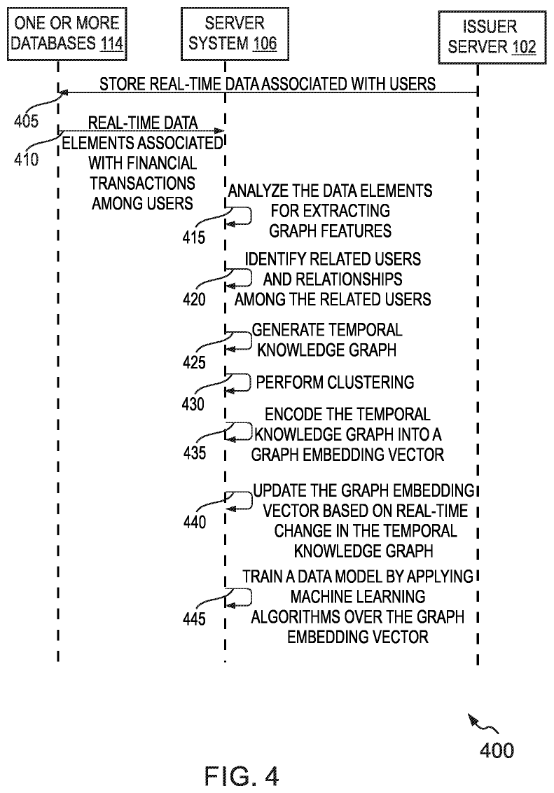

FIG. 4 represents a sequence flow diagram of a process flow associated with anti-money laundering systems during a training stage, in accordance with an example embodiment;

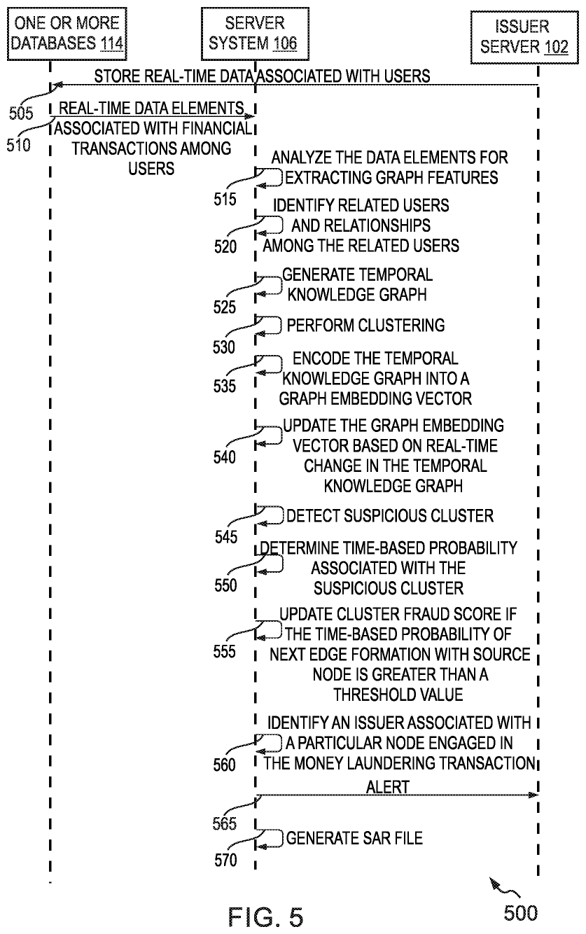

FIG. 5 represents a sequence flow diagram of a process flow associated with anti-money laundering systems during an execution stage, in accordance with an example embodiment;

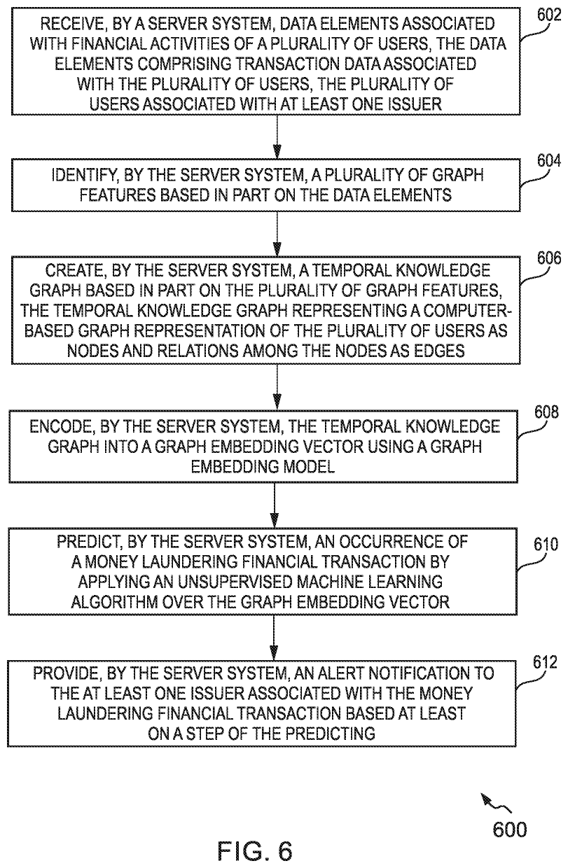

FIG. 6 represents a flow diagram of a method for detecting potential money laundering financial transactions, in accordance with an example embodiment;

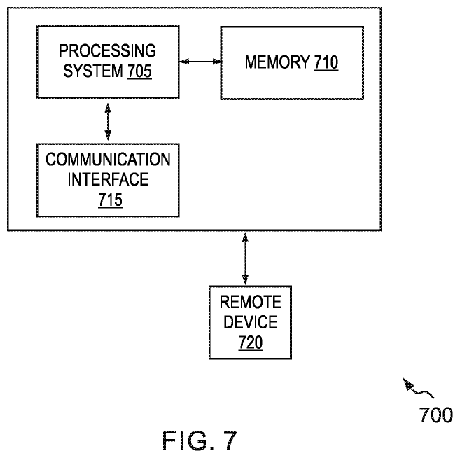

FIG. 7 is a simplified block diagram of a payment server, in accordance with one embodiment of the present disclosure;

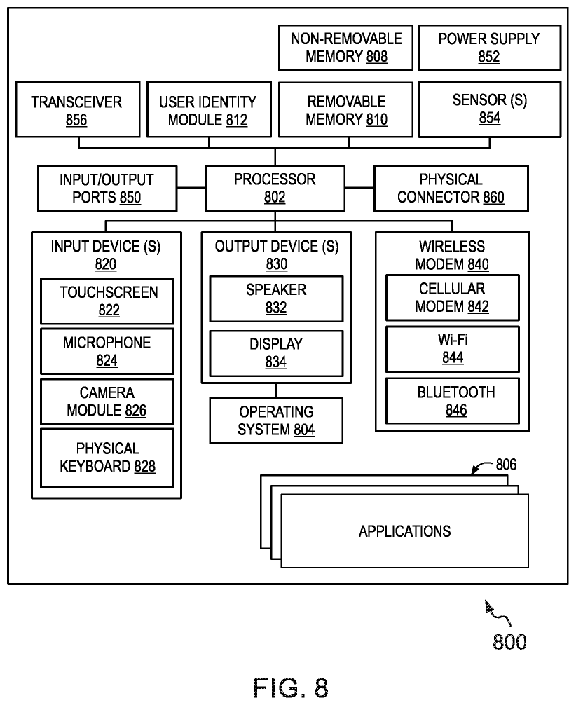

FIG. 8 is a simplified block diagram of a user device associated with a user capable of implementing at least some embodiments of the present disclosure; and

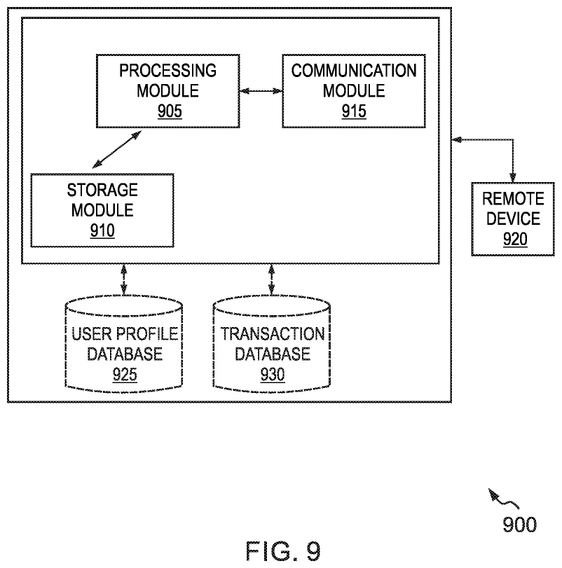

FIG. 9 is a simplified block diagram of an issuer server, in accordance with one embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment network”, used throughout the description, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by various payment interchange networks such as Mastercard®.

Overview

Various example embodiments of the present disclosure provide methods, systems, user devices and computer program products for determining future money laundering financial transactions among users proactively and providing alert notifications to issuers for preventing future money laundering financial transaction in near real time.

In various example embodiments, the present disclosure describes a server system that facilitates detection of potential money laundering financial transactions. The server system is configured to receive data elements associated with financial activities among a plurality of users from one or more databases. The plurality of users are associated with at least one issuer. The data elements are stored at the one or more databases such as, for example, user profile database, transaction database, social behavioral database, and fraud and chargeback database. The data elements include information related to transaction data associated with the plurality of users, user profile data, social behavioral data, and fraud and chargeback data.

The server system is configured to identify a plurality of graph features based on the data elements. The plurality of graph features includes, but is not limited to, location data associated with the financial activities, population density data, historical fraud data, transaction velocity data, and transaction history. The plurality of graph features are utilized for generating a temporal knowledge graph. The server system is configured to identify a set of related users who are engaged in the financial activities and relationships among the related users. Based on the related users and relationships among the related users, the server system is configured to create the temporal knowledge graph which contains heterogeneous information into a single entity relation that changes with time. The temporal knowledge graph represents a computer-based graph representation of the plurality of users as nodes and relations among the nodes as edges.

In one embodiment, the server system is configured to cluster a set of related nodes in a single cluster of a set of clusters by utilizing a known clustering algorithm. In one non-limiting example, a temporal knowledge graph associated with a set of users, who are engaged in financial transactions among themselves during a span of time, is clustered in the same cluster. In other words, nodes associated with the set of users are clustered into the same cluster as each node is connected with one or more remaining nodes of the set of nodes.

In one embodiment, the server system is configured to encode the temporal knowledge graph into a graph embedding vector using a graph embedding model. The graph embedding model represents a combination of node embedding, edge embedding, and subtree graph embedding algorithms. The server system is configured to compute a first vector representation associated with each node of temporal knowledge graph using the node embedding algorithm. The server is also configured to compute second and third vector representations associated with each edge and sub-graph of the temporal knowledge graph using the edge embedding and the subtree graph embedding algorithms, respectively. Additionally, the server system is configured to aggregate the first, second and third vector representations for generating the graph embedding vector.

In one embodiment, the server system is configured to apply machine learning algorithms over the graph embedding vector for training a data model to facilitate prediction of missing links in the temporal knowledge graph. The missing links may be related to money laundering financial transactions.

In one embodiment, when the server system identifies a suspicious cluster from the set of clusters with a likelihood of occurring money laundering financial transactions, the server system is configured to flag the cluster for further actions. The identification is performed by applying behavior edge clustering algorithm over the temporal knowledge graph. In one example, the suspicious cluster may be identified based on historical fraud data associated with the one or more nodes present in the suspicious cluster. Thus, flagging the suspicious cluster enables reduction of search space of clusters for exploring the future financial transactions being the money laundering financial transactions.

Thereafter, the server system is configured to predict the occurrence of the money laundering financial transaction by applying an unsupervised machine learning algorithm. In one embodiment, the unsupervised machine learning algorithm is a Long Short-Term Memory (LSTM) network. More particularly, the server system is configured to determine time-based probabilities of next edge formation within the suspicious cluster and next edge formation outside the suspicious cluster. The server system is configured to determine whether a time-based probability of next edge formation leading to a source node is greater than a predetermined threshold value. In response to a determination that the time-based probability of the next edge formation leading to the source node is greater than the predetermined threshold value, the server system is configured to provide a real-time alert notification to the at least one issuer for preventing the money laundering financial transaction.

In one embodiment, the server system is configured to generate a suspicious activity report (SAR) file associated with the suspicious cluster and provide the SAR file to the regulators for further actions. The SAR file includes, but is not limited to, a cluster fraud score, a node fraud score, and a prediction probability associated with a next transaction being the money laundering financial transaction.

Various embodiments of the present disclosure offer multiple advantages and technical effects. For instance, the present disclosure provides an automated system for predicting next financial transactions of suspicious customers in near real-time which can be used to take pre-emptive action and help in enriching the SAR file for AML systems.

Various example embodiments of the present disclosure are described hereinafter with reference to FIGS. 1 to 9.

FIG. 1 illustrates an exemplary representation of a system 100 related to at least some example embodiments of the present disclosure. Although the system 100 is presented in one arrangement, other embodiments may include the parts of the system 100 (or other parts) arranged otherwise depending on, for example, identifying a probabilistic money laundering financial transactions, etc. The system 100 generally includes an issuer 102 including a plurality of issuers 102a, 102b and 102c, a plurality of users or cardholders 104a, 104b, and 104c, a payment network 108, each coupled to, and in communication with (and/or with access to) a network 110. The network 110 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among two or more of the parts or users illustrated in FIG. 1, or any combination thereof. Various entities in the system 100 may connect to the network 110 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof.

For example, the network 110 may include multiple different networks, such as a private network made accessible by the payment network 108 to the plurality of issuers 102a, 102b, 102c, separately, a public network (e.g., the Internet etc.) through which the plurality of users 104a, 104b, 104c and the plurality of issuers 102a, 102b, 102c may communicate. The plurality of issuers 102a, 102b, 102c hereinafter are collectively represented as a “the issuer 102” or “the issuer server 102”. The user and the cardholder are used interchangeably throughout the present disclosure.

The system 100 includes a server system 106 configured to perform one or more of the operations described herein. In general, the server system 106 is configured to determine future money laundering financial transactions among the plurality of users. In a more illustrative manner, the server system 106 provides an anti-money laundering (AML) system for detecting future money laundering financial transactions. The server system 106 is a separate part of the system 100, and may operate apart from (but still in communication with, for example, via the network 110) the plurality of issuers 102, the payment network 108, and any third party external servers to determine futuristic money laundering financial transactions (and to access data to perform the various operations described herein). However, in other embodiments, the server system 106 may actually be incorporated, in whole or in part, into one or more parts of the system 100, for example, the payment network 108. In addition, the server system 106 should be understood to be embodied in at least one computing device in communication with the network 110, which may be specifically configured, via executable instructions, to perform as described herein, and/or embodied in at least one non-transitory computer readable media.

The cardholder (i.e., “the user 104a, 104b, or 104c”) may operate a user device (e.g., 124a, 124b, or 124c) to conduct a payment transaction through a payment gateway application. In one embodiment, the cardholder (i.e., “the user 104a”) may also use a payment card (e.g., “swipe” or present a payment card) at a POS terminal. The user (i.e., “the user 104a”) may be any individual, representative of a corporate entity, non-profit organization, or any other person that is presenting credit or debit card during a financial transaction. The cardholder (i.e., “the user 104a”) may have a payment account issued by an issuing bank (associated with the issuer server 102) and may be provided the payment card with financial or other account information encoded onto the payment card such that the cardholder (i.e., “the user 104a”) may use the payment card to initiate and complete a transaction using a bank account at the issuing bank. Non-financial transactions may also be completed using the payment card provided by an issuer but in the interest of brevity, the system of FIG. 1 focuses on a payment transaction.

The issuer server 102 is a computing server that is associated with the issuer bank. The issuer bank is a financial institution that manages accounts of multiple users. Account details of the accounts established with the issuer bank are stored in user profiles of the users in a memory of the issuer server 102 or on a cloud server associated with the issuer server 102.

The user device is a communication device of the user (i.e., “the user 104a”). The user 104a uses the user device to access a mobile application or a website of the issuer server 102a, or any third party payment application. The user device and the mobile device are used interchangeably throughout the present description. The user device may be any electronic device such as, but not limited to, a personal computer (PC), a tablet device, a Personal Digital Assistant (PDA), a voice activated assistant, a Virtual Reality (VR) device, a smartphone and a laptop.

The system 100 also includes one or more databases 114 communicatively coupled to the server system 106. The one or more databases 114 include user profile database 116, social behavioral database 118, transaction database 120, and fraud and chargeback database 122. In one embodiment, the one or more databases 114 may include multifarious data, for example, social media data, Know Your Customer (KYC) data, payment data, trade data, employee data, Anti Money Laundering (AML) data, market abuse data, Foreign Account Tax Compliance Act (FATCA) data, credit Bureau data, and Human Resource (HR) data.

The user profile database 116 stores user profile data associated with each user. The user profile data may include an account balance, a credit line, and details of the cardholder (i.e., “the user 104a”), account identification information, payment card number, or the like. The details of the cardholder 104a may include, but not limited to, name, age, gender, physical attributes, location, registered contact number, family information, alternate contact number, registered e-mail address, or the like of the cardholder 104a.

The social behavioral database 118 includes social media data associated with each user which may include, but not limited to, Twitter™ Feeds, Email communication, Facebook™ posts, LinkedIn™ updates, messaging applications, and voice data. To extract social medial data or the new age data, new age tools are used that may include, but are not limited to, Flume™, Storm™, and Kafka™.

The transaction database 120 stores real time transaction data of the plurality of users. The transaction data may include, but not limited to, transaction attributes, such as transaction amount, source of funds such as bank or credit cards, transaction channel used for loading funds such as POS terminal or ATM machine, transaction velocity such as count and transaction amount sent in the past x days to a particular user, transaction location information, external data sources and other internal data to evaluate each transaction. The fraud and chargeback database 122 stores historical fraudulent chargeback activities associated with the plurality of users.

In one embodiment, the payment network 108 may be used by the payment cards issuing authorities as a payment interchange network. The payment network 108 may include a plurality of payment servers such as, a payment server 112. Examples of payment interchange network include, but are not limited to, Mastercard® payment system interchange network. The Mastercard® payment system interchange network is a proprietary communications standard promulgated by Mastercard International Incorporated® for the exchange of financial transactions among a plurality of financial activities that are members of Mastercard International Incorporated®. (Mastercard is a registered trademark of Mastercard International Incorporated located in Purchase, N.Y.).

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the system 100 may perform one or more functions described as being performed by another set of systems or another set of devices of the system 100.

Referring now to FIG. 2, a simplified block diagram of a server system 200, in accordance with an embodiment of the present disclosure, is shown. The server system 200 is similar to the server system 106. In one embodiment, the server system 200 is a part of the payment network 108 or integrated within the payment server 112. In one embodiment, the server system 200 is the issuer server 102. The server system 200 includes a processor 202, a memory 204, and a communication interface 206 that communicate with each other via a bus 208. The processor 202 includes a data pre-processing engine 210, a knowledge graph creation engine 212, a clustering engine 214, a graph embedding encoder 216, a training engine 218, and a prediction engine 220.

The processor 202 includes suitable logic, circuitry, and/or interfaces to execute operations for receiving various data elements associated with financial transactions that are received from one or more entities, such as, the one or more databases 114, the issuer server 102, and any third party servers. Examples of the processor 202 include, but are not limited to, an application-specific integrated circuit (ASIC) processor, a reduced instruction set computing (RISC) processor, a complex instruction set computing (CISC) processor, a field-programmable gate array (FPGA), and the like. The memory 204 includes suitable logic, circuitry, and/or interfaces to storing a set of computer readable instructions for performing operations. Examples of the memory 204 include a random-access memory (RAM), a read-only memory (ROM), a removable storage drive, a hard disk drive (HDD), and the like. It will be apparent to a person skilled in the art that the scope of the disclosure is not limited to realizing the memory 204 in the server system 200, as described herein. In another embodiment, the memory 204 may be realized in the form of a database server or a cloud storage working in conjunction with the server system 200, without departing from the scope of the present disclosure.

The processor 202 is operatively coupled to the communication interface 206 such that the processor 202 is capable of communicating with a remote device 222 such as, the issuer server 102, the one or more databases 114, and the payment server 112, respectively or communicated with any entity connected to the network 110 (shown in FIG. 1). The processor 202 receives data elements from the one or more databases 114 via the communication interface 206.

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

The data pre-processing engine 210 includes suitable logic and/or interfaces for analyzing data elements associated with financial transactions performed by the plurality of users. The data pre-processing engine 210 accesses the data elements stored in the one or more databases 114. The data elements may include, but not limited to, financial transaction data, user profile data, social behavioral data, fraud and chargeback data, geo-location data of the financial activities, demographic data etc. The user profile data may include information that the user (i.e., “the user 104a”) has provided to the banking institution or the issuer 102 (i.e., “the issuer 102a”) when he opened an account, including personal data (e.g., location, age, bank accounts and their location, financial sources, occupation, ownership structures, associations with other entities or individuals. The social behavioral data may include information of social connection among the plurality of users, who are engaged in the financial activities among themselves.

In one embodiment, the data pre-processing engine 210 may use natural language processing (NLP) algorithms to extract a plurality of graph features based on the data elements. The plurality of graph features are utilized to create a temporal knowledge graph. The plurality of graph features may include, but not limited to, geolocation data associated with the financial transactions, population density, transaction velocity (i.e., frequency of financial transaction among users), historical fraud data, and transaction history. In one embodiment, the geolocation data associated with the financial transactions may include information or data associated with identification or estimation of real-world geographic location of the mobile device, or web-based computer or processing device.

It should be appreciated that data acquired for the temporal knowledge graph generation may involve open semantic databases, more reputable sources of web content, open crawl databases, or other similar source. This may be based on the semantic nature of the temporal knowledge graph. In other words, meaning of data may be encoded alongside data in a graph, usually in an ontological form. Because the temporal knowledge graph is self-descriptive, it may be important to use higher quality sources to make the necessary relationships, as described in more detail below.

In one embodiment, the data pre-processing engine 210 may identify one or more related users from the plurality of users based on the plurality of graph features. The one or more related users may have one or more relationships among them. In one embodiment, the data pre-processing engine 210 may perform data mining for removing duplicity of data.

The knowledge graph creation engine 212 includes suitable logic and/or interfaces for creating the temporal knowledge graph based in part on the identified plurality of graph features. In general, the temporal knowledge graph contains heterogeneous information into a single entity relation that changes with time. The knowledge graph creation engine 212 may generate the temporal knowledge graph that associates one or more related nodes using one or more relationships. In this case, the temporal knowledge graph may include nodes (e.g., nodes relating to the payment card numbers associated with a user and one or more related users, etc.) and edges (e.g., edges representing one or more relationships among the related nodes). In at least some embodiments, the temporal knowledge graph is a node-based structure including a plurality of nodes. One or more nodes from the plurality of nodes are connected to one or more remaining nodes using respective edges.

Additionally, the temporal knowledge graph may include metadata associated with the nodes, and/or information identifying the one or more relationships (such as, for example, financial transaction, social connection, fraud connection etc.) among the nodes. The social connection among the nodes is determined based at least on a matching of data elements such as, the user profile data, mutual friends on social media etc. The fraud connection represents fraud financial activities among users during past time.

In one example scenario, a party ‘X’ transfers $1000 to a party ‘Y’ who is a nephew of the party ‘X’. In the above example scenario, the temporal knowledge graph has two nodes depicting the party ‘X’ (i.e., source node) and the party ‘Y’ (i.e., destination node) and edges of two types between them, where one edge represents financial transactions between the nodes and another edge represents social connection (i.e., “nephew-uncle”) between the nodes.

The clustering engine 214 includes suitable logic and/or interfaces for clustering the related nodes in a same group using a known node clustering algorithm. In other words, the clustering engine 214 clusters a set of related nodes of the temporal knowledge graph in a single cluster of a set of clusters. The node clustering aims to group similar nodes together, so that nodes in the same group are more similar to each other than those in other groups. In one example, a cluster from the set of clusters has all the nodes which are engaged in financial transactions during a span of time. In another example, a cluster from the set of clusters has all the nodes which have some kind of social connection among themselves.

“Clustering” generally refers to a process of grouping a set of data or objects (e.g., accounts, transactions, etc.) into a set of meaningful subclasses called “clusters” according to a natural grouping or structure of the graph data. Clustering generally is a form of data mining or data discovery used in unsupervised machine learning of unlabeled data.

The graph embedding encoder 216 includes suitable logic and/or interfaces for converting the temporal knowledge graph into an embedding space using a graph embedding model. More particularly, the graph embedding model may transform these temporal knowledge graphs into corresponding vector representations. In general, the graph embedding model converts graph data into a low dimensional space in which graph structural information and graph properties are preserved at most.

In one embodiment, the graph embedding model may be determined by applying sampling, mapping, and optimization processes on the temporal knowledge graph. In the sampling process, samples (e.g., two nodes and a relation between them) are extracted. In the mapping process, embedding stacking operations (e.g., pooling, averaging, etc.) are applied on the samples. In the optimization process, a set of optimization functions are applied to find a graph embedding that preserves original properties of the temporal knowledge graph. The set of optimization functions may be, but not limited to, root mean squared error (RMSE), Log likelihood, etc.

In one embodiment, a best graph embedding model may be determined by applying algorithms (such as, for example, Deepwalk, Matrix factorization, Large-scale information network embedding (LINE), Bayesian personalized ranking, graphlet algorithms etc.) over the temporal knowledge graph.

In one embodiment, the graph embedding model represents a combination of node embedding, edge embedding and sub-tree graph embedding methods. The graph embedding encoder 216 encodes each node of the temporal knowledge graph in a first vector representation using the node embedding method. Closer nodes in the temporal knowledge graph are embedded in a similar vector representation. The node embedding method utilizes such edge reconstruction methods which maximize edge reconstruction probability. In other words, output result of the node embedding method should be able to preserve edge connections more while determining which all nodes or edges may be involved in money laundering activities.

The graph embedding encoder 216 encodes each edge of the temporal knowledge graph in a second vector representation using the edge embedding method. In general, the edge embedding method is utilized for predicting missing links among the nodes in an incomplete temporal knowledge graph. Further, the subtree graph embedding method is utilized for encoding each sub-graph of the temporal knowledge graph in a third vector representation so that different entity relations of the temporal knowledge graph across different sub-graphs are preserved.

In one embodiment, the graph embedding encoder 216 aggregates the first, second, and third vector representations for generating a graph embedding vector. In one embodiment, the graph embedding encoder 216 is configured to concatenate the first, second, and third vector representations for generating the graph embedding vector.

The training engine 218 is configured to apply machine learning algorithms over the graph embedding vector for training a data model 224 to facilitate prediction of missing links in the temporal knowledge graph. The data model 224 is stored in the memory 204. The missing links may be related to money laundering financial transactions.

In one embodiment, the machine learning algorithms may be, supervised and/or unsupervised techniques, such as those involving artificial neural networks, association rule learning, recurrent neural networks (RNN), Bayesian networks, clustering, deep learning, decision trees, genetic algorithms, Hidden Markov Modeling, inductive logic programming, learning automata, learning classifier systems, logistic regressions, linear classifiers, quadratic classifiers, reinforcement learning, representation learning, rule-based machine learning, similarity and metric learning, sparse dictionary learning, support vector machines, and/or the like.

In some embodiments, the training engine 218 implements a sequence neural network for training the data model 224. As an example, the sequence neural network may be trained to output a dense vector representation of transaction data related to the plurality of users. In one use case, with respect to financial transactions between two users, the training engine 218 may rely on a long short-term memory (LSTM) network (or other sequence neural network) to train the data model by consuming the real-time graph embedding vectors. Based on the trained data model, the LSTM network may predict next money laundering financial transactions.

In one embodiment, when the clustering engine 214 detects a suspicious cluster from the set of clusters with a likelihood of occurring next financial transaction being the money laundering financial transaction, the clustering engine 214 flags/marks the suspicious cluster. In one non-limiting example, the clustering engine utilizes behavior edge clustering algorithms for detecting the suspicious cluster. In one embodiment, the suspicious cluster may be identified based on the historical fraud data associated with the one or more nodes present in the suspicious cluster.

The prediction engine 220 is configured to predict the next financial transaction being the money laundering financial transaction, based on the trained data model. The prediction engine 220 is configured to determine time-based probabilities associated with the flagged cluster. The time-based probabilities may include, but not limited to, a time-based probability of next edge formation within the flagged cluster, a time-based probability of next edge formation outside the flagged cluster with a nearby cluster. In one embodiment, the time-based probability of the next edge formation within the flagged cluster is determined by constructing a Long Short Term Memory (LSTM) network for the flagged cluster using the trained data model. In one embodiment, the time-based probability of next edge formation outside the flagged cluster with the nearby cluster is determined by generating a convolution network. These time-based probabilities are used to detect nodes/groups/transactions that might lead to the money laundering financial transaction.

In one embodiment, if the time-based probability of the next edge formation leading to a source node is greater than a predetermined threshold value, the prediction engine 220 identifies an issuer associated with a particular node (i.e., a trailing node) related to the next edge (i.e., link) which may be linked in future money-laundering activities. The source node refers to a node from where all the financial transactions were initiated previously.

In one embodiment, the processor 202 is configured to determine the issuer identifier or BIN (Bank Identification Number) of the issuer associated with a user of the particular node using his/her payment card number or account identification number.

In one embodiment, the processor 202 is configured to update fraud score of the flagged cluster and the particular node based on the time-based probabilities.

Additionally, the processor 202 is configured to generate a suspicious activity report (SAR) file and alert the identified issuer 102 for preventing fraudulent financial transactions based on the SAR file. The SAR file may include, but not limited to, a cluster fraud score, a node fraud score, and a prediction probability associated with the next financial transaction being the money laundering financial transaction.

FIGS. 3A-3F, collectively, represent example representations of a process for predicting a probable money laundering financial transaction on a real time basis using the server system 106, in accordance with an example embodiment.

Referring now to FIGS. 3A-3C, example representations of temporal knowledge graphs created at different timestamps by the server system 106 are shown, in accordance with an example embodiment of the present disclosure. The server system 106 creates a temporal knowledge graph based on the plurality of graph features. The plurality of graph features may include, but not limited to, geolocation data associated with the financial transactions, population density, transaction velocity (i.e., frequency of financial transaction among users), historical fraud data, and transaction history. The temporal knowledge graph represents a computer-based graph representation of the plurality of users as nodes and relations among the nodes as edges. The relationship among the nodes are set forth in solid, dashed, and/or bolded lines (e.g., with arrows). The server system 106 also determines weights and directions of edges based on the plurality of graph features (not shown in figures).

As shown in FIG. 3A, at timestamp T=0, a user A associated with an issuer bank “XYZ” transfers $1000 among users B, C, D, who may be associated with different banks. In the transaction, the users B, C. and D have received $500, $200, and $300, respectively. The server system 106 also determines that user B is a nephew of the user A, the user C is a mother of A and the user D has a business contract with the user A. Thereafter, a temporal knowledge graph 300 (i.e., A→B, A→C, A→D) is generated using the aforementioned information. In addition, the server system 106 identifies that the user B was engaged in fraud financial activities in past time, therefore, the user B is marked as a suspicious user (shown as a hatch shaded circle) in the temporal knowledge graph 300.

In one embodiment, the server system 106 may update the temporal knowledge graph 300 by adding nodes, adding edges, removing nodes, removing edges, adding additional metadata for existing nodes, removing metadata for existing nodes, and/or the like. In this case, the server system 106 updates the temporal knowledge graph 300 by adding additional nodes and edges that identify the new relationships.

As shown in FIG. 3B, a temporal knowledge graph 302 represents a graph data structure at timestamp T=T₁. At the timestamp T=T₁, the users B and C transfer $500 and $100, respectively, to a user E and the users C and D transfer $100 and $300, respectively, to a user F (e.g., B→E, C→E, C→F, D→F). Further, a user G transfers $1000 to a user H and $500 to a user I (e.g., G→H).

As shown in FIG. 3C, the temporal knowledge graph 304 represents a graph data structure at timestamp T=T₂. At the timestamp T₂ (i.e., T₂>T₁), the users E and F transfer the received amount to the user A (e.g., E→A, F→A). Hence, the temporal knowledge graph is time dependent as the transactions and behavior of users keep on changing with time.

Referring now to FIG. 3D, an example representation of clustering process of the temporal knowledge graph 304 is shown, in accordance with an example embodiment of the present disclosure. The server system 106 is configured to cluster related nodes in a same group using a known node clustering algorithm. In some implementations, the server system 106 may determine one or more similarity-based relationships. For example, the server system 106 may determine a degree of similarity among the related nodes based on whether the users share a common field of business, whether the demographic data of a user is in close proximity to the related users. Additionally, the server system 106 may assign weight values to the related users, and may use the weighted values to determine a degree of similarity among the related users.

As shown in the FIG. 3D, the temporal knowledge graph 304 is divided in two clusters 306a and 306b. Further, the server system 106 marks/flags a cluster (see, 306a) as a suspicious cluster using behavior edge clustering algorithms.

Referring now to FIG. 3E, an example representation of graph embedding generation associated with the flagged cluster (see, 306a in FIG. 3D) is shown, in accordance with an example embodiment of the present disclosure. The server system 106 is configured to encode the temporal knowledge graph associated with the flagged cluster (see, 306a in FIG. 3D) into an embedding space using a graph embedding model 308. The graph embedding model 308 represents a combination of node embedding, edge embedding, and sub-tree graph embedding methods. The server system 106 is configured to compute a first vector representation (see, 308a) of each node of the temporal knowledge graph associated with the flagged cluster (see, 306a in FIG. 3D) using the node embedding method. The server system 106 is configured to compute a second vector representation (see, 308b) of each edge of the temporal knowledge graph associated with the flagged cluster (see, 306a in FIG. 3D) using the edge embedding method. In addition, the server system 106 is configured to compute a third vector representation (see, 308c) of each sub-graph of the temporal knowledge graph associated with the flagged cluster (see, 306a in FIG. 3D) using the subtree graph embedding method.

Thereafter, the server system 106 is configured to aggregate the first, second and the third vector representations for generating a graph embedding vector.

Referring now to FIG. 3F, an example representation of predicting a next financial transaction is shown, in accordance with an example embodiment of the present disclosure. The server system 106 is configured to determine next link (i.e., “edge formation”) probability by applying recurrent neural network (e.g., “LS™ network”) over the graph embedding vector. In the aforementioned example, the next link probabilities for the edges E→A and F→A are 0.90 and 0.95, which are greater than the predetermined threshold value (e.g., “0.80”). The next link probability values represent merely an example. Since, the edges E→A and F→A lead to a source node (i.e., “node A”) from where the financial transaction of transaction amount $1000 was initiated, therefore, the edges E→A and F→A may result money laundering financial transactions in future. In response, the server system 106 is configured to send alerts for preventing those transactions to associated issuers in near real time.

FIG. 4 represents a sequence flow diagram 400 of a process flow associated with anti-money laundering systems during a training stage, in accordance with an example embodiment. The sequence of operations of the sequence flow diagram 400 may not be necessarily executed in the same order as they are presented. Further, one or more operations may be grouped together and performed in form of a single step, or one operation may have several sub-steps that may be performed in parallel or in sequential manner.

At 405, the issuer server 102 stores real time data associated with a plurality of users in the one or more databases 114. The issuer server 102 stores transaction data associated with the plurality of users in the transaction database 120. Further, the issuer server 102 stores user profile data associated with the plurality of users in the user profile database 116.

At 410, the server system 106 receives real time data elements associated with financial transactions performed among the plurality of users from the one or more databases 114. The data elements include, but are not limited to, user profile data, transaction history data, social connection, fraud and chargeback data, and demographic data etc.

At 415, the server system 106 analyzes the data elements for extracting a plurality of graph features. In one embodiment, the server system 106 may use natural language processing (NLP) algorithms for determining the plurality of graph features based at least on the received data elements. The plurality of graph features may include, but not limited to, geolocation data associated with the financial transactions, population density, transaction velocity (i.e., frequency of financial transaction by a user to a particular user), historical fraud data, and transaction history. The historical fraud data may provide information of users who were engaged in fraud financial activities.

At 420, based on the plurality of graph features, the server system 106 identifies one or more related users from the plurality of users and relationship among the plurality of users.

At 425, the server system 106 generates a temporal knowledge graph based on the plurality of graph features. The temporal knowledge graph represents the one or more related users engaged in the financial transactions as related nodes and relations among the related nodes as edges. The edges may be, but not limited to, geolocation data associated with the financial transaction, social connection, and fraud connection.

At 430, the server system 106 performs clustering of related nodes of the temporal knowledge graph in a single cluster of a set of clusters.

At 435, the server system 106 encodes the temporal knowledge graph into a graph embedding vector using a graph embedding model. The graph embedding model represents a combination of node embedding, edge embedding, and subtree graph embedding techniques. The server system 106 determines a first vector representation associated with each node of the temporal knowledge graph using the node embedding technique. In a similar manner, the server system 106 also determines a second vector representation associated with each edge of the temporal knowledge graph using the edge embedding technique and a third vector representation associated with each sub-graph of the temporal knowledge graph using the subtree graph embedding technique.

In one embodiment, the server system 106 aggregates the first, second and third vector representations to generate a graph embedding vector. In one embodiment, the server system 106 concatenates the first, second and third vector representations to generate a graph embedding vector.

At 440, the server system 106 updates the graph embedding vector based on real-time changes such as, for example, addition or subtraction of nodes and edges, in the temporal knowledge graph.

At 445, the server system 106 trains a data model by applying machine learning algorithms over the graph embedding vector. In one embodiment, the machine learning algorithms may be a recurrent neural network (e.g., Long Short Term Memory (LSTM)). The trained data model is utilized for predicting missing links in the temporal knowledge graph.

FIG. 5 represents a sequence flow diagram 500 of a process flow associated with anti-money laundering systems during an execution stage, in accordance with an example embodiment. The sequence of operations of the sequence flow diagram 500 may not be necessarily executed in the same order as they are presented. Further, one or more operations may be grouped together and performed in form of a single step, or one operation may have several sub-steps that may be performed in parallel or in sequential manner. The process till step 540 of FIG. 5 remains same as process till step 440 as described with reference to FIG. 4. For the sake of brevity, the detailed explanation till the step 540 is omitted herein with reference to FIG. 4.

At 545, when the server system 106 detects a suspicious cluster from the set of clusters with a likelihood of occurring the money laundering financial transaction, the server system 106 flags the cluster as suspicious.

At 550, the server system 106 determines time-based probabilities associated with the suspicious cluster. The time-based probabilities may be, but not limited to, a probability of next edge formation within the suspicious cluster, a probability of next edge formation outside the suspicious cluster with a nearby cluster etc. In one embodiment, the probability of next edge formation within the suspicious cluster is determined by constructing a Long Short Term Memory (LSTM) network for the suspicious cluster using the trained data model. The probability of next edge formation outside the suspicious cluster with the nearby cluster is determined by generating a convolution network. These time-based probabilities are used to detect nodes/groups/transactions that might lead to a money laundering transaction.

At 555, if the probability of the next edge formation with a source node (e.g., “node A” as shown in FIG. 3C) from a particular node (e.g., “node F” as shown in FIG. 3C) of the suspicious cluster (see, 306a of FIG. 3D) is greater than a predetermined threshold value, the server system 106 updates a cluster fraud score of the suspicious cluster and a node fraud score of the particular node which may be linked in future money-laundering activities.

At 560, the server system 106 identifies an issuer associated with the particular node, which may be engaged in the money laundering financial transactions. In one embodiment, an issuer identifier of the issuer is identified based on a payment card number associated with the particular node.

At 565, the server system 106 alerts the issuer for preventing the money laundering financial transactions performed by a user associated with the particular node.

At 570, the server system 106 generates a suspicious activity report (SAR) file and provides the SAR file to the regulators for further actions. The SAR file includes, but is not limited to, information related to a cluster fraud score, a node fraud score, and a prediction probability associated with a next transaction being the money laundering financial transaction.

Referring now to FIG. 6, it illustrates a flow diagram of a method 600 for detecting potential money laundering financial transactions, in accordance with an example embodiment. The method 600 depicted in the flow diagram may be executed by, for example, the at least one server system 106. Operations of the method 600, and combinations of operation in the method 600, may be implemented by, for example, hardware, firmware, a processor, circuitry and/or a different device associated with the execution of software that includes one or more computer program instructions. The method 600 starts at operation 602.

At the operation 602, the method 600 includes receiving, by the server system 106, data elements associated with financial activities of a plurality of users (e.g., “the plurality of users 104a, 104b, 104c”). The data elements are accessed from the one or more databases 114 and include at least transaction data associated with the plurality of users. The plurality of users are associated with at least one issuer (e.g., “issuer 102a”).

At operation 604, the method 600 includes identifying, by the server system 106, a plurality of graph features based at least on the data elements.

At operation 606, the method 600 includes creating, by the server system 106, a temporal knowledge graph based on the plurality of graph features. The temporal knowledge graph represents a computer-based graph representation of the plurality of users as nodes and relations among the nodes as edges.

At operation 608, the method 600 includes encoding, by the server system 106, the knowledge temporal graph into a graph embedding vector using a graph embedding model. The graph embedding model represents a combination of node embedding, edge embedding and subtree graph embedding algorithms.

At operation 610, the method 600 includes predicting, by the server system, an occurrence of a money laundering financial transaction by applying an unsupervised machine learning algorithm over the graph embedding vector. In one embodiment, the unsupervised machine learning algorithm is a recurrent neural network (RNN).

At operation 612, the method 600 includes providing, by the server system 106, an alert notification to the at least one issuer associated with the money laundering financial transaction based on the predicting step.

FIG. 7 is a simplified block diagram of a payment server 700, in accordance with an embodiment of the present disclosure. The payment server 700 is an example of the payment server 112 of FIG. 1. The payment network 108 may be used by the payment server 700, the issuer server 102 and an acquirer server as a payment interchange network. Examples of payment interchange network include, but not limited to, Mastercard® payment system interchange network. The payment server 700 includes a processing system 705 configured to extract programming instructions from a memory 710 to provide various features of the present disclosure. Further, two or more components may be embodied in one single component, and/or one component may be configured using multiple sub-components to achieve the desired functionalities. Some components of the payment server 700 may be configured using hardware elements, software elements, firmware elements and/or a combination thereof. In one embodiment, the payment server 700 is configured to determine potential money laundering financial transactions.

Via a communication interface 715, the processing system 705 receives information from a remote device 720 such as the issuer server 102, the one or more databases 114, or a user device hosting a payment gateway application. The payment server 700 may also perform similar operations as performed by the server system 200 for determining potential money laundering financial transactions. For the sake of brevity, the detailed explanation of the payment server 700 is omitted herein with reference to the FIG. 2.

FIG. 8 shows a simplified block diagram of a user device 800, for example, a mobile phone or a desktop computer capable of implementing the various embodiments of the present disclosure. For example, the user device 800 may correspond to the user device 124a, 124b, or 124c of FIG. 1. The user device 800 is depicted to include one or more applications 806 (e.g., “payment application”). The applications 806 can be an instance of an application downloaded from a third-party server.

It should be understood that the user device 800 as illustrated and hereinafter described is merely illustrative of one type of device and should not be taken to limit the scope of the embodiments. As such, it should be appreciated that at least some of the components described below in connection with the user device 800 may be optional and thus in an example embodiment may include more, less or different components than those described in connection with the example embodiment of the FIG. 8. As such, among other examples, the user device 800 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 800 includes a controller or a processor 802 (e.g., a signal processor, microprocessor, ASIC, or other control and processing logic circuitry) for performing such tasks as signal coding, data processing, image processing, input/output processing, power control, and/or other functions. An operating system 804 controls the allocation and usage of the components of the user device 800 and supports for one or more payment transaction applications programs (see, the applications 806), that implements one or more of the innovative features described herein. In addition, the applications 806 may include common mobile computing applications (e.g., telephony applications, email applications, calendars, contact managers, web browsers, messaging applications) or any other computing application.

The illustrated user device 800 includes one or more memory components, for example, a non-removable memory 808 and/or removable memory 810. The non-removable memory 808 and/or the removable memory 810 may be collectively known as a database in an embodiment. The non-removable memory 808 can include RAM, ROM, flash memory, a hard disk, or other well-known memory storage technologies. The removable memory 810 can include flash memory, smart cards, or a Subscriber Identity Module (SIM). The one or more memory components can be used for storing data and/or code for running the operating system 804 and the applications 806. The user device 800 may further include a user identity module (UIM) 812. The UIM 812 may be a memory device having a processor built in. The UIM 812 may include, for example, a subscriber identity module (SIM), a universal integrated circuit card (UICC), a universal subscriber identity module (USIM), a removable user identity module (R-UIM), or any other smart card. The UIM 812 typically stores information elements related to a mobile subscriber. The UIM 812 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 800 can support one or more input devices 820 and one or more output devices 830. Examples of the input devices 820 may include, but are not limited to, a touch screen/a display screen 822 (e.g., capable of capturing finger tap inputs, finger gesture inputs, multi-finger tap inputs, multi-finger gesture inputs, or keystroke inputs from a virtual keyboard or keypad), a microphone 824 (e.g., capable of capturing voice input), a camera module 826 (e.g., capable of capturing still picture images and/or video images) and a physical keyboard 828. Examples of the output devices 830 may include, but are not limited to a speaker 832 and a display 834. Other possible output devices can include piezoelectric or other haptic output devices. Some devices can serve more than one input/output function. For example, the touch screen 822 and the display 834 can be combined into a single input/output device.

A wireless modem 840 can be coupled to one or more antennas (not shown in the FIG. 8) and can support two-way communications between the processor 802 and external devices, as is well understood in the art. The wireless modem 840 is shown generically and can include, for example, a cellular modem 842 for communicating at long range with the mobile communication network, a Wi-Fi compatible modem 844 for communicating at short range with an external Bluetooth-equipped device or a local wireless data network or router, and/or a Bluetooth-compatible modem 846. The wireless modem 840 is typically configured for communication with one or more cellular networks, such as a GSM network for data and voice communications within a single cellular network, between cellular networks, or between the user device 800 and a public switched telephone network (PSTN).

The user device 800 can further include one or more input/output ports 850, a power supply 852, one or more sensors 854, for example, an accelerometer, a gyroscope, a compass, or an infrared proximity sensor for detecting the orientation or motion of the user device 800 and biometric sensors for scanning biometric identity of an authorized user, a transceiver 856 (for wirelessly transmitting analog or digital signals) and/or a physical connector 860, which can be a USB port, IEEE 1294 (FireWire) port, and/or RS-232 port. The illustrated components are not required or all-inclusive, as any of the components shown can be deleted and other components can be added.

FIG. 9 is a simplified block diagram of an issuer server 900 used for facilitating payment transactions of users, in accordance with an example embodiment of the present disclosure. The issuer server 900 is an example of the plurality of issuers 102a, 102b, and 102c of FIG. 1. The issuer server 900 is associated with an issuer bank/issuer, in which a user (e.g., “the user 104a”) may have an account, which provides a payment card. The issuer server 900 includes a processing module 905 operatively coupled to a storage module 910 and a communication module 915. The components of the issuer server 900 provided herein may not be exhaustive and the issuer server 900 may include more or fewer components than those depicted in FIG. 9. Further, two or more components may be embodied in one single component, and/or one component may be configured using multiple sub-components to achieve the desired functionalities. Some components of the issuer server 900 may be configured using hardware elements, software elements, firmware elements and/or a combination thereof.

The storage module 910 is configured to store machine executable instructions to be accessed by the processing module 905. Additionally, the storage module 910 stores information related to, contact information of the user, bank account number, availability of funds in the account, payment card details, transaction details and/or the like. Further, the storage module 910 is configured to store payment transactions.

In one embodiment, the issuer server 900 is configured to store user profile data (e.g., an account balance, a credit line, details of the cardholder (i.e., “the user 104a”), account identification information, payment card number) in the user profile database 116. The details of the cardholder may include, but not limited to, name, age, gender, physical attributes, location, registered contact number, family information, alternate contact number, registered e-mail address, or the like of the cardholder etc.

The processing module 905 is configured to communicate with one or more remote devices such as a remote device 920 using the communication module 915 over a network such as the network 110 of FIG. 1. The examples of the remote device 920 include the server system 106, the payment server 112, one or more databases 114 or other computing systems of issuer server 900 and the network 110 and the like. The communication module 915 is capable of facilitating such operative communication with the remote devices and cloud servers using API (Application Program Interface) calls. The communication module 915 is configured to receive a payment transaction request performed by the user (i.e., “the user 104a”) via the network 110. The processing module 905 receives a payment card information, a payment transaction amount, a customer information and merchant information from the remote device 920 (i.e. the user device or the payment server 112). The issuer server 900 includes a transaction database 930 for storing transaction data. The transaction data may include, but not limited to, transaction attributes, such as transaction amount, source of funds such as bank or credit cards, transaction channel used for loading funds such as POS terminal or ATM machine, transaction velocity such as count and transaction amount sent in the past x days to a particular user, transaction location information, external data sources and other internal data to evaluate each transaction. The issuer server 900 includes a user profile database 925 storing user profile associated with a plurality of users.

In one embodiment, the issuer server 900 is also configured to store historical fraudulent chargeback activities associated with the plurality of users in the fraud and chargeback database 122. The user profile data may include an account balance, a credit line, and details of the cardholder (i.e., “the user 104a”), account identification information, payment card number, or the like. The details of the cardholder (i.e., “the user 104a”) may include, but not limited to, name, age, gender, physical attributes, location, registered contact number, family information, alternate contact number, registered e-mail address, or the like of the cardholder (i.e., “the user 104a”).

The disclosed method with reference to FIG. 6, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method for detecting potential money laundering financial transactions, the computer-implemented method comprising:
receiving, by a server system, data elements associated with financial activities of a plurality of users, the data elements comprising transaction data associated with the plurality of users, the plurality of users associated with at least one issuer;
identifying, by the server system, a plurality of graph features based in part on the data elements;
creating, by the server system, a temporal knowledge graph based in part on the plurality of graph features, the temporal knowledge graph representing a computer-based graph representation of the plurality of users as nodes and relations among the nodes as edges;
encoding, by the server system, the temporal knowledge graph into a graph embedding vector using a graph embedding model;
predicting, by the server system, an occurrence of a money laundering financial transaction by applying an unsupervised machine learning algorithm over the graph embedding vector; and
providing, by the server system, an alert notification to the at least one issuer associated with the money laundering financial transaction based at least on a step of the predicting.

2. The computer-implemented method of claim 1, wherein the data elements further comprise user profile data, social behavioral data associated with the plurality of users who are engaged in the financial activities, and fraud and chargeback data.

3. The computer-implemented method of claim 2, wherein the plurality of graph features comprises location data associated with the financial activities, population density data, historical fraud data, transaction velocity data, and transaction history.

4. The computer-implemented method of claim 1, wherein the graph embedding model represents a combination of node embedding, edge embedding and subtree graph embedding algorithms, and wherein encoding the temporal knowledge graph into the graph embedding vector comprises:
computing, by the server system, a first vector representation associated with each node of the temporal knowledge graph based at least on the node embedding algorithm;
computing, by the server system, a second vector representation associated with each edge of the temporal knowledge graph based at least on the edge embedding algorithm;
computing, by the server system, a third vector representation associated with each sub-graph of the temporal knowledge graph based at least on the subtree graph embedding algorithm; and
aggregating, by the server system, the first, second, and third vector representations to generate the graph embedding vector.

5. The computer-implemented method of claim 1, further comprising:
updating, by the server system, the graph embedding vector based at least on real-time addition or subtraction of nodes and edges in the temporal knowledge graph.

6. The computer-implemented method of claim 1, further comprising:
performing, by the server system, clustering of a set of related nodes of the temporal knowledge graph in a cluster of a set of clusters; and
flagging, by the server system, a cluster from the set of clusters with a likelihood of occurring a money laundering financial transaction based in part on a behavior edge clustering algorithm.

7. The computer-implemented method of claim 6, wherein predicting the occurrence of the money laundering financial transaction comprises:
determining, by the server system, a time-based probability of next edge formation within the flagged cluster by applying the unsupervised machine learning algorithm;
determining, by the server system, a time-based probability of next edge formation outside the flagged cluster; and
determining, by the server system, whether a time-based probability of next edge formation leading to a source node is greater than a predetermined threshold value or not.

8. The computer-implemented method of claim 7, further comprising in response to determining that the time-based probability of the next edge formation leading to the source node is greater than the predetermined threshold value, providing, by the server system, the alert notification to the at least one issuer for preventing the money laundering financial transaction.

9. The computer-implemented method of claim 1, further comprising generating, by the server system, a suspicious activity report (SAR) file, the SAR file comprising a cluster fraud score, a node fraud score, and a prediction probability associated with a next transaction being the money laundering financial transaction.

10. A server system, comprising:
a communication interface;
a memory comprising executable instructions; and
a processor communicably coupled to the communication interface, the processor configured to execute the executable instructions to cause the server system to at least:
receive data elements associated with financial activities of a plurality of users, the data elements comprising transaction data associated with the plurality of users, wherein the plurality of users are associated with at least one issuer,
identify a plurality of graph features based in part on the data elements,
create a temporal knowledge graph based in part on the plurality of graph features, the temporal knowledge graph representing a computer-based graph representation of the plurality of users as nodes and relations among the nodes as edges,
encode the temporal knowledge graph into a graph embedding vector using a graph embedding model,
predict an occurrence of a money laundering financial transaction by applying an unsupervised machine learning algorithm over the graph embedding vector, and
provide an alert notification to the at least one issuer associated with the money laundering financial transaction based at least on the prediction.

11. The server system of claim 10, wherein the data elements further comprise user profile data, social behavioral data associated with the plurality of users who are engaged in the financial activities, and fraud and chargeback data.

12. The server system of claim 10, wherein the plurality of graph features comprises location data associated with the financial activities, population density data, historical fraud data, transaction velocity data, and transaction history.

13. The server system of claim 10, wherein the graph embedding model represents a combination of node embedding, edge embedding, and subtree graph embedding algorithms, and wherein, to encode the temporal knowledge graph into the graph embedding vector, the server system is further caused to:
compute a first vector representation associated with each node of the temporal knowledge graph based at least on the node embedding algorithm,
compute a second vector representation associated with each edge of the temporal knowledge graph based at least on the edge embedding algorithm,
compute a third vector representation associated with each sub-graph of the temporal knowledge graph based at least on the subtree graph embedding algorithm, and
aggregate the first, second, and third vector representation to generate the graph embedding vector.

14. The server system of claim 10, wherein the server system is further caused to update the graph embedding vector based at least on real-time addition or subtraction of nodes and edges in the temporal knowledge graph.

15. The server system of claim 10, wherein the server system is further caused to:
perform clustering of a set of related nodes of the temporal knowledge graph in a cluster of a set of clusters, and
flag a cluster from the set of clusters with a likelihood of occurring the money laundering financial transaction based in part on a behavior edge clustering algorithm.

16. The server system of claim 15, wherein, to predict the occurrence of the money laundering financial transaction, the server system is further caused to:
determine a time-based probability of next edge formation within the flagged cluster by applying the unsupervised machine learning algorithm,
determine a time-based probability of next edge formation outside the flagged cluster, and
determine whether a time-based probability of next edge formation leading to a source node is greater than a predetermined threshold value or not.

17. The server system of claim 16, wherein the server system is further caused to:
in response to a determination that the time-based probability of the next edge formation leading to the source node is greater than the predetermined threshold value, provide the alert notification to the at least one issuer for preventing the money laundering financial transaction.

18. A computer-implemented method for detecting potential money laundering financial transactions, the computer-implemented method comprising:
receiving, by a server system, data elements associated with financial activities of a plurality of users, the data elements comprising transaction data associated with the plurality of users, wherein the plurality of users are associated with at least one issuer;
identifying, by the server system, a plurality of graph features based in part on the data elements;
generating, by the server system, a temporal knowledge graph based in part on the plurality of graph features, the temporal knowledge graph representing a computer-based graph representation of the plurality of users as nodes and relations among the nodes as edges;
encoding, by the server system, the temporal knowledge graph into a graph embedding vector using a graph embedding model, the graph embedding model representing a combination of node embedding, edge embedding and subtree graph embedding algorithms;
predicting, by the server system, an occurrence of a money laundering financial transaction by applying a long short term memory (LSTM) network algorithm over the graph embedding vector; and
providing, by the server system, an alert notification to the at least one issuer associated with the money laundering financial transaction based at least on a step of the predicting.

19. The computer-implemented method of claim 18, further comprising:
computing, by the server system, a time-based probability of next edge formation leading to a source node;
determining, by the server system, whether the time-based probability of the next edge formation leading to the source node is greater than a predetermined threshold value or not; and
in response to the determining that the time-based probability of the next edge formation leading to the source node is greater than the predetermined threshold value, provide the alert notification to the at least one issuer for preventing the money laundering financial transaction.

20. The computer-implemented method of claim 19, further comprising generating, by the server system, a suspicious activity report (SAR) file, the SAR file comprising a cluster fraud score, a node fraud score, and a prediction probability associated with a next transaction being the money laundering financial transaction.
